(19) United States
(12) Patent Application Publication
(10) Pub. No.: US 2026/0366516 A1
(43) Pub. Date: Nov. 19, 2026

(54) ELECTRONIC DEVICE FOR PREDICTING AIR LEAKAGE IN AIR COMPRESSOR AND METHOD OF OPERATING THE SAME

(71) Applicant: ELECTRONICS AND TELECOMMUNICATIONS RESEARCH INSTITUTE, Daejeon (KR)

(72) Inventors: Yoon-Sik YOO, Daejeon (KR); II Woo LEE, Daejeon (KR); Nakyoung KIM, Daejeon (KR); Jangkyum KIM, Daejeon (KR)

(21) Appl. No.: 19/577,820

(22) Filed: Mar. 25, 2026

(30) Foreign Application Priority Data
May 15, 2025 (KR) 10-2025-0063073

(51) Int. Cl. F04D 27/00; G06N 3/048

(52) U.S. Cl. CPC F04D 27/001; G06N 3/048

(57) ABSTRACT

An electronic device for predicting air leakage in an air compressor and a method of operating the electronic device are provided. The method includes, in operating states of an inlet guide vane (IGV) and a bleed off valve (BOV) of an air compressor, receiving operational data measured via at least one sensor disposed in the air compressor, extracting feature data by inputting the received operational data to a first neural network and embedding the received operational data in a latent space, predicting an IGV value and a BOV value of the air compressor by inputting the extracted feature data to a second neural network, and predicting an air leakage probability in the air compressor by inputting the predicted IGV value and the predicted BOV value to a third neural network.

### CROSS-REFERENCE TO RELATED APPLICATION

This application claims the benefit of Korean Patent Application No. 10-2025-0063073, filed on May 15, 2025, in the Korean Intellectual Property Office, the entire disclosure of which is incorporated herein by reference for all purposes.

### BACKGROUND

### 1. Field of the Invention

One or more embodiments relate to an electronic device for predicting air leakage in an air compressor and a method of operating the electronic device.

### 2. Description of the Related Art

An air compressor used in various industrial fields may experience air leakage or surge phenomena during operation. Such air leakage or surge phenomena not only degrade the operational efficiency of the air compressor but also cause significant economic losses.

When a surge phenomenon occurs, air within the air compressor is not compressed and the intake air is simply discharged into the atmosphere. As a result, the pressure balance inside the air compressor is disrupted, leading to increased instability. In particular, in manufacturing environments such as smart factories, such air leakage may have a substantial impact on overall operations.

To more effectively detect air leakage, recent studies have developed systems that combine deep learning models with Internet of Things (IoT) technologies. These systems enable real-time data collection and analysis, making it possible to predict issues and take preventive measures before air leakage occurs. However, such systems have limitations in that stable performance may not be guaranteed. Consequently, there remain challenges in addressing surge phenomena or inefficient air leakage caused by instability of air compressors.

The above information may be presented as the related art to help with the understanding of the disclosure. No arguments or decisions are raised to whether any of the above description is applicable as the prior art related to the present disclosure.

### SUMMARY

Embodiments provide an electronic device for predicting air leakage that may occur in an air compressor in advance using a deep learning model and a method of operating the electronic device.

In addition, embodiments provide an electronic device that may accurately and rapidly determine whether air leakage occurs based on an airflow correction (AC) value predicted from operating states of an inlet guide vane (IGV) and a bleed-off valve (BOV) of an air compressor and a method of operating the electronic device.

However, the technical aspects are not limited to the aspects described above, and there may be other technical aspects.

According to an aspect, there is provided an electronic device including at least one processor and memory including one or more storage media storing instructions, wherein the instructions, when executed by the at least one processor individually or collectively, may cause the electronic device to, in operating states of an IGV and a BOV of an air compressor, receive operational data measured via at least one sensor disposed in the air compressor, extract feature data by inputting the received operational data to a first neural network and embedding the received operational data in a latent space, predict an IGV value and a BOV value of the air compressor by inputting the extracted feature data to a second neural network, and predict an air leakage probability in the air compressor by inputting the predicted IGV value and the predicted BOV value to a third neural network.

The first neural network may include a plurality of fully connected layers connected one after another.

The instructions, when executed by the at least one processor individually or collectively, may cause the electronic device to extract the feature data by converting the received operational data into a dimension corresponding to a number of nodes of a last fully connected layer among the plurality of fully connected layers.

The second neural network may include a plurality of fully connected layers configured to independently predict the IGV value and the BOV value of the air compressor.

The instructions, when executed by the at least one processor individually or collectively, may cause the electronic device to independently predict the IGV value and the BOV value of the air compressor by inputting the extracted feature data to each of the plurality of fully connected layers.

The second neural network may be a result of training using a first loss function for minimizing a prediction error of the predicted IGV value, a prediction error of the predicted BOV value, and a prediction error of a predicted AC value between the BOV and the IGV.

The second neural network may be a result of training using a second loss function to which triplet loss is applied for distinguishing, based on the predicted IGV value and the predicted BOV value, between an air leakage state and a normal state.

The third neural network may include a softmax layer and a plurality of fully connected layers connected one after another.

The third neural network may be a result of training using a third loss function to which binary cross-entropy loss is applied for minimizing a difference between the predicted air leakage probability and an actual air leakage probability.

The instructions, when executed by the at least one processor individually or collectively, may cause the electronic device to determine that air leakage occurs in the air compressor when the predicted air leakage probability is greater than or equal to a predetermined threshold.

The instructions, when executed by the at least one processor individually or collectively, may cause the electronic device to predict an AC value from the predicted IGV value and the predicted BOV value and analyze whether air leakage occurs in the air compressor by applying the predicted AC value to a Gaussian mixture model (GMM).

The instructions, when executed by the at least one processor individually or collectively, may cause the electronic device to determine, using the predicted AC value and a decision boundary set in the GMM including a first number of Gaussian distributions representing AC values in a normal state and a second number of Gaussian distributions representing AC values in an air leakage state, whether air leakage occurs in the air compressor.

The decision boundary set in the GMM may be defined as a point at which a sum of probability densities of the first number of Gaussian distributions is equal to a sum of probability densities of the second number of Gaussian distributions.

The operational data may include at least one of temperature, humidity, pressure, maximum load, minimum load, and compressed air temperature within the air compressor.

According to another aspect, there is provided a method of operating an electronic device, the method including, in operating states of an IGV and a BOV of an air compressor, receiving operational data measured via at least one sensor disposed in the air compressor, extracting feature data by inputting the received operational data to a first neural network and embedding the received operational data in a latent space, predicting an IGV value and a BOV value of the air compressor by inputting the extracted feature data to a second neural network, and predicting an air leakage probability in the air compressor by inputting the predicted IGV value and the predicted BOV value to a third neural network.

The first neural network may include a plurality of fully connected layers connected one after another, and the extracting of the feature data may include extracting the feature data by converting the received operational data into a dimension corresponding to a number of nodes of a last fully connected layer among the plurality of fully connected layers.

The second neural network may include a plurality of fully connected layers configured to independently predict the IGV value and the BOV value of the air compressor, and the predicting of the IGV value and the BOV value of the air compressor my include independently predicting the IGV value and the BOV value of the air compressor by inputting the extracted feature data to each of the plurality of fully connected layers.

The second neural network maybe a result of training using a first loss function for minimizing a prediction error of the predicted IGV value, a prediction error of the predicted BOV value, and a prediction error of a predicted AC value between the BOV and the IGV and using a second loss function to which triplet loss is applied for distinguishing, based on the predicted IGV value and the predicted BOV value, between an air leakage state and a normal state.

The third neural network may include a softmax layer and a plurality of fully connected layers connected one after another and is a result of training using a third loss function to which binary cross-entropy loss is applied for minimizing a difference between the predicted air leakage probability and an actual air leakage probability, and the predicting of the air leakage probability in the air compressor may include determining that air leakage occurs in the air compressor when the predicted air leakage probability is greater than or equal to a predetermined threshold.

The predicting of the air leakage probability in the air compressor may include predicting an AC value from the predicted IGV value and the predicted BOV value and analyzing whether air leakage occurs in the air compressor by applying the predicted AC value to a GMM, and the analyzing of whether air leakage occurs in the air compressor may include determining, using the predicted AC value and a decision boundary set in the GMM including a first number of Gaussian distributions representing AC values in a normal state and a second number of Gaussian distributions representing AC values in an air leakage state, whether air leakage occurs in the air compressor.

Additional aspects of embodiments will be set forth in part in the description which follows and, in part, will be apparent from the description, or may be learned by practice of the disclosure.

According to embodiments, air leakage that may occur in an air compressor may be predicted in advance using a deep learning model.

In addition, according to embodiments, whether air leakage occurs may be accurately and rapidly determined based on an AC value predicted from operating states of an IGV and

BOV of an air compressor.

### BRIEF DESCRIPTION OF THE DRAWINGS

With regard to the description of the drawings, the same or similar reference numerals may be used to refer to the same or similar components.

These and/or other aspects, features, and advantages of the invention will become apparent and more readily appreciated from the following description of embodiments, taken in conjunction with the accompanying drawings of which:

FIG. 1 is a diagram illustrating an electronic device for predicting air leakage in an air compressor according to an embodiment;

FIG. 2 is a diagram illustrating a method of predicting air leakage in an air compressor, the method being performed by an electronic device according to an embodiment;

FIG. 3 is a diagram illustrating an operating map of an air compressor according to an embodiment; and

FIG. 4 is a diagram illustrating a probability density distribution of airflow correction (AC) data to which a Gaussian mixture model (GMM) is applied, according to an embodiment.

### DETAILED DESCRIPTION

The following structural or functional descriptions of embodiments are provided as examples only, and various alterations and modifications may be made to the embodiments. Accordingly, the embodiments are not to be construed as limited to the disclosure and should be understood to include all changes, equivalents, or replacements within the idea and the technical scope of the disclosure.

As used herein, “A or B,” “at least one of A and B,” “at least one of A or B,” “A, B or C,” “at least one of A, B and C,” “at least one of A, B, or C,” and “one or a combination of at least two of A, B, and C,” each of which may include any one of the items listed together in the corresponding one of the phrases, or all possible combinations thereof. Although terms, such as first, second, and the like, may be used herein to describe various components, these terms should be used only to distinguish one component from another component. For example, a first component may be referred to as a second component, and similarly, the second component may also be referred to as the first component.

It should be noted that if it is described that one component is “connected,” “coupled,” or “joined” to another component, a third component may be “connected,” “coupled,” and “joined” between the first and second components, although the first component may be directly connected, coupled, or joined to the second component.

As used herein, the singular form is intended to include the plural forms as well, unless the context clearly indicates otherwise. It will be understood that the terms “comprises/comprising” and/or “includes/including” when used herein, specify the presence of stated features, integers, steps, operations, elements, components, or groups thereof, but do not preclude the presence or addition of one or more other features, integers, steps, operations, elements, components, or groups thereof.

Unless otherwise defined, all terms, including technical and scientific terms, used herein have the same meaning as commonly understood by one of ordinary skill in the art to which the present disclosure pertains. Terms, such as those defined in commonly used dictionaries, are to be interpreted as having a meaning that is consistent with their meaning in the context of the relevant art, and are not to be interpreted in an idealized or overly formal sense unless expressly so defined herein.

Hereinafter, embodiments are described in detail with reference to the accompanying drawings. When describing the embodiments with reference to the accompanying drawings, like reference numerals refer to like elements, and a repeated description related thereto is omitted.

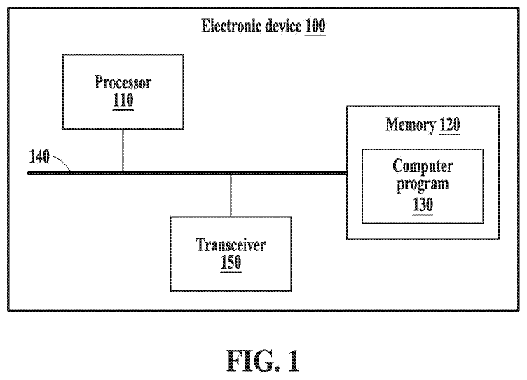

FIG. 1 is a diagram illustrating an electronic device for predicting air leakage in an air compressor according to an embodiment.

Referring to FIG. 1, an electronic device 100 may include a processor 110, which includes one or more processors, and memory 120 that may load or store a computer program 130 executed by the processor 110. The processor 110 and the memory 120 may be connected to one another via a communication link 140 (e.g., a bus). Optionally, the electronic device 100 may further include a transceiver 150. The transceiver 150 may be used for data exchange, such as transmission and/or reception of data between the electronic device 100 and another electronic device. The components included in the electronic device 100 of FIG. 1 are only examples, and those skilled in the art may understand that other general-purpose components may be further included in addition to the components illustrated in FIG. 1.

The processor 110 may control the overall operation of each of the components of the electronic device 100. The processor 110 may be implemented as circuitry (e.g., processing circuitry) such as a system on chip (SoC) or an integrated circuit (IC). The processor 110 may include one or more processors. For example, the processor 110 may include a combination of one or more processors, such as a central processing unit (CPU), a microprocessor unit (MPU), a microcontroller unit (MCU), a graphics processing unit (GPU), a neural processing unit (NPU), a digital signal processor (DSP), an application processor (AP), a communication processor (CP), or any other processors well known in the technical field of the disclosure. In addition, the processor 110 may perform an operation of at least one application or the computer program 130 to execute the methods/operations according to various embodiments of the disclosure.

The memory 120 may store one of, or a combination of two or more of, various pieces of data, instructions, and pieces of information that are used by a component (e.g., the processor 110) included in the electronic device 100. The memory 120 may include volatile memory and/or non-volatile memory.

The computer program 130 may include one or more actions through which the methods/operations according to various embodiments are implemented and may be stored in the memory 120 as software. In this case, an action may correspond to an instruction that is implemented in the computer program 130. For example, the computer program 130 may include instructions to perform an operation of receiving operational data measured via at least one sensor disposed in an air compressor in operating states of an inlet guide vane (IGV) and a bleed off valve (BOV) of the air compressor, an operation of extracting feature data by inputting the received operational data to a first neural network and embedding the received operational data in a latent space, an operation of predicting an IGV value and a BOV value of the air compressor by inputting the extracted feature data to a second neural network, and an operation of predicting an air leakage probability in the air compressor by inputting the predicted IGV value and the predicted BOV value to a third neural network.

When the computer program 130 is loaded in the memory 120, the processor 110 may execute a plurality of operations to implement the computer program 130 and perform the methods/operations according to various embodiments.

The communication link 140 may include a path for transmitting at least one of various pieces of data, instructions, and information between the components included in the electronic device 100. The communication link 140 may be, for example, a peripheral component interconnect (PCI) bus or an extended industry standard architecture (EISA) bus; however, these bus types are only examples and not limited thereto. For example, in FIG. 1, a bus is represented by a single line for ease of description, but in practice, a plurality of buses or various types of buses may be included.

Herein, the air compressor may control air intake and air discharge by utilizing an IGV and a BOV, thereby controlling the internal pressure by correcting the internal airflow.

First, the IGV may control the flow and pressure of air flowing into the air compressor. That is, the air compressor may stably maintain the internal pressure by controlling the IGV to adjust the amount of air flowing into the air compressor.

Next, the BOV may control the internal pressure of the air compressor. That is, the air compressor may prevent abnormal operation, such as a surge phenomenon, by releasing air to the outside through the BOV to reduce the internal pressure.

In this way, the air compressor may ensure the efficiency and stability of the air compressor by precisely controlling the airflow within the air compressor by interlinking the operations of the IGV and the BOV, and may maintain various required air compression conditions.

Herein, air leakage of the air compressor may be defined as an intentional release of excessive air due to a predetermined factor, rather than an unexpected loss of air due to a defect in the air compressor. That is, herein, air leakage may be defined as a case in which the airflow of the BOV is excessively greater than the airflow of the IGV, which may indicate that the internal pressure may be reduced through airflow correction (AC).

Herein, a deep learning model may be provided to predict air leakage in advance during operation of the air compressor in order to predict the instability of the air compressor. A deep learning model is described in detail with reference to the following drawings.

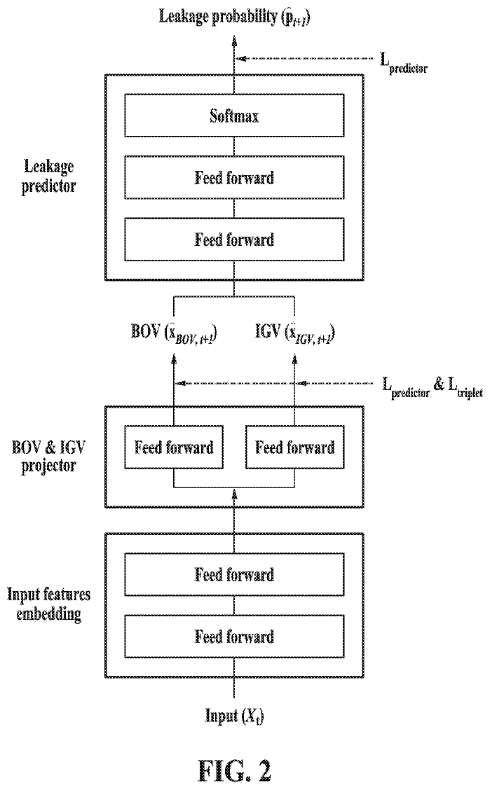

FIG. 2 is a diagram illustrating a method of predicting air leakage of an air compressor, the method being performed by an electronic device according to an embodiment. In an embodiment, at least one of the operations of FIG. 2 may be performed simultaneously or in parallel with another operation, and the order of the operations may be changed. In addition, at least one of the operations may be omitted, or another operation may be additionally performed. The operations illustrated in FIG. 2 may be performed by at least one component of an electronic device (e.g., the electronic device 100 of FIG. 1).

A processor (e.g., the processor 110 of FIG. 1) of the electronic device may receive operational data measured via at least one sensor disposed in an air compressor, in response to operating states of an IGV and a BOV of the air compressor. In this case, the received operational data may include various features indicating changes in the state of the air compressor over time. For example, the operational data may include at least one of the features including temperature, humidity, pressure, maximum load, minimum load, and compressed air temperature within the air compressor. The types of operational data described above are only examples and are not limited to the examples above.

A feature set of operational data may be represented as [symbol] , and individual features included in the feature set may be processed as a single piece of univariate time series data. In this case, for a given length T, a past operational data sequence at a time t may be expressed by Equation 1 below.

x_{m,t}=(x_{m,t-τ+1})_{τ∈|T|}, ∀m∈ [symbol] <Equation 1>

Here, x_{m,t} may represent the value of the m-th feature at the time t.

In addition, multivariate time series data including features included in the feature set [symbol] for a given length T may be expressed by Equation 2 below.

Xₜ= [symbol] <Equation 2>

The processor may extract feature data by inputting the received operational data to a first neural network (e.g., input features embedding of FIG. 2) and embedding the received operational data in a latent space. In this case, the feature embedding process may be expressed by Equation 3 below.

f_{embedding}: [symbol] <Equation 3>

Here, [symbol] may represent operational data including | [symbol] |, the number of features, and the time length T. [symbol] may represent an embedding space after dimension reduction. That is, the processor may embed a feature for subsequent air leakage prediction by flattening the received operational data and then applying a plurality of fully connected layers connected one after another. In this case, an embedded dimension d may be determined by the number of nodes in the last fully connected layer among the plurality of fully connected layers.

The processor may predict an IGV value and a BOV value of the air compressor by inputting the extracted feature data to a second neural network (e.g., a BOV and IGV projector of FIG. 2). In this case, the operation of the second neural network that predicts the IGV value and the BOV value may be expressed by Equation 4 below.

f_{projector}: [symbol] <Equation 4>

In this case, the second neural network may include a plurality of (e.g., two) fully connected layers that independently predicts the IGV value and the BOV value of the air compressor, and may independently predict the two values: the IGV value and the BOV value of the air compressor, by receiving d-dimension vector generated from the embedded feature through the first neural network. In this case, the second neural network may predict more precise IGV and BOV values by reflecting an AC value derived from the predicted IGV and BOV values.

For this, the second neural network may be trained in a way that minimizes a first loss function (e.g., L_{projector}) that simultaneously considers a prediction error of the predicted L IGV value, a prediction error of the predicted BOV value, and a prediction error of a predicted AC value between the BOV and the IGV, as expressed in Equation 5 below.

$${L}_{projector} = \frac{1}{N} {\sum }_{i = 1}^{N} [ {\underbrace{{‖ {x}_{BOV , i} - {\hat{x}}_{BOV , i} ‖}_{2}^{2}}}_{BOV loss} + {\underbrace{{‖ {x}_{IGV , i} - {\hat{x}}_{IGV , i} ‖}_{2}^{2}}}_{IGV loss} + {\underbrace{{‖ ( {x}_{BOV , i} - {x}_{IGV , i} ) - ( {\hat{x}}_{BOV , i} - {\hat{x}}_{IGV , i} ) ‖}_{1}}}_{AC loss} ] \qquad < Equation 5 >$$

Here, x and \hat{x} may represent an actual measured value and a value predicted through the second neural network, respectively. That is, the second neural network may be trained to minimize the prediction error of the predicted IGV value and the prediction error of the predicted BOV value, while also keeping the difference between the two predicted values constant.

Additionally, the second neural network may be trained using a second loss function to which triplet loss is applied. The triplet loss is a loss function used in machine learning that may train samples with the same label to be located closer together in an embedding space (latent space) and train samples with different labels to be located farther apart.

In this way, the second loss function to which the triplet loss considering air leakage is applied in the second neural network may be expressed by Equation 6 below.

$${L}_{triplet} = \frac{1}{N} {\sum }_{i = 1}^{N} [ 1 - \frac{{\sum }_{{\hat{x}}_{p} ∈ {P}_{i}} cos ( {\hat{x}}_{i} , {\hat{x}}_{p} )}{\vert {P}_{i} \vert} + ( 1 + \frac{{\sum }_{{\hat{x}}_{n} ∈ {N}_{i}} cos ( {\hat{x}}_{i} , {\hat{x}}_{n} )}{\vert {N}_{i} \vert} ) ] \qquad < Equation 6 >$$

Here, Pᵢ={(\hat{x}ⱼ, [symbol] )∈D| [symbol] , for some (\hat{x}ᵢ, [symbol] )∈D} may represent a set of samples with the same label as [symbol] , and Nᵢ={(\hat{x}ⱼ, [symbol] )∈D| [symbol] , for some (\hat{x}ᵢ, [symbol] )∈D} may represent a set of samples with different labels from [symbol] .

In addition, D may represent a set of data samples including the predicted IGV value and the predicted BOV value and actual air leakage labels of the predicted IGV value and the predicted BOV value. \hat{x}ᵢ=[\hat{x}_{BOV},i, \hat{x}_{IGV,i] may represent a vector representation of the predicted BOV value and the predicted IGV value in a predetermined sample i. Furthermore, cosine similarity, which represents the similarity between two vectors, may be defined as}

$$cos ( a , b ) = \frac{a \cdot b}{‖ a ‖ ‖ b ‖} .$$

The triplet loss imposes relative distance constraints during a learning process, which may help the second neural network learn a meaningful pattern for distinguishing between abnormal data with air leakage and normal data without air leakage. That is, the second neural network may more clearly distinguish between abnormal data and normal data depending on the presence or absence of air leakage by learning to place samples with similar patterns close together and place samples with different patterns far apart through the triplet loss.

The processor may predict the probability of air leakage occurring in the air compressor by inputting the predicted IGV value and the predicted BOV value to a third neural network (e.g., a leakage predictor of FIG. 2). In this case, the third neural network may include a softmax layer and a plurality of fully connected layers connected one after another and may be trained using a third loss function to which binary cross-entropy loss is applied for minimizing the difference between the predicted air leakage probability and the actual air leakage probability.

In this case, the third loss function applied to the third neural network may be expressed by Equation 7 below.

$${L}_{predictor} = - \frac{1}{N} {\sum }_{i = 1}^{N} [ {y}_{i} \cdot log ( {\hat{p}}_{i} ) + ( 1 - {y}_{i} ) \cdot log ( 1 - {\hat{p}}_{i} ) ] \qquad < Equation 7 >$$

Here, [symbol] may represent whether actual air leakage occurs (e.g., 1 (leakage occurs) or 0 (normal)), and \hat{p}ᵢ may represent the probability of air leakage occurrence predicted through the third neural network. In this case, \hat{p}ᵢ may be expressed as a probability value between 0 and 1, and based on a predetermined threshold, the processor may determine whether air leakage occurs.

For example, the processor may set a predetermined threshold to 0.5, as shown in Equation 8 below.

$${\hat{y}}_{i} = \{ \begin{matrix}1 & if {\hat{p}}_{i} \geq 0.5 , \\ 0 & otherwise .\end{matrix} \qquad < Equation 8 >$$

That is, the processor may determine that air leakage occurs ( [symbol] =1) in the air compressor when \hat{p}ᵢ is 0.5 or greater and may determine that the air compressor is in a normal state when \hat{p}ᵢ is less than 0.5.

Therefore, the processor may improve the accuracy of predicting air leakage in the air compressor by learning to minimize a final loss function (L_{leakage}) including three loss functions as expressed in Equation 9 below.

L_{leakage}=L_{projector}+Lₜᵣᵢₚₗₑₜ+L_{predictor} <Equation 9>

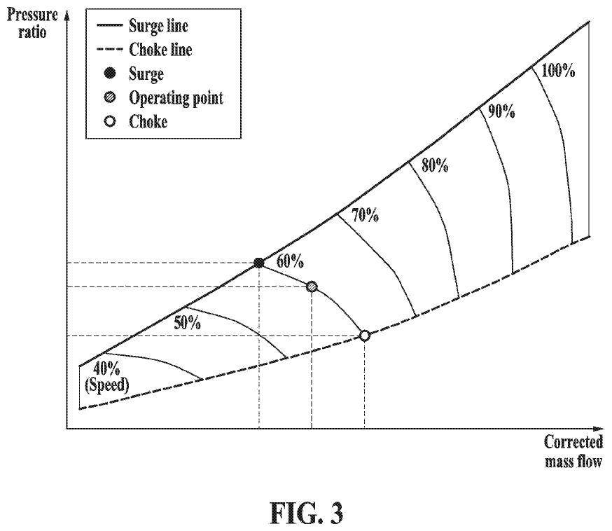

Operating points of the air compressor may be divided into three types, such as an operating point near a surge line, an operating point near a choke line, and an operating point in a stable operating zone between the surge line and the choke line, as illustrated in FIG. 3. In this case, the operating points may be determined by a pressure ratio, corrected mass flow, and turbo speed.

When the pressure ratio and turbo speed are fixed at desired values, airflow values of the BOV and the IGV may determine the operating points. When an operating point is in the stable operating zone, either the BOV value or the IGV value may be relatively greater, depending on whether the pressure ratio needs to be increased or decreased.

In contrast, when an operating point is near the surge line or choke line, the airflow in the BOV may be significantly greater than the airflow in the IGV, or vice versa, to prevent the air compressor from surging or choking.

Therefore, based on the current operating point of the air compressor and an AC value required to achieve a set pressure ratio, the processor may classify the operating state of the air compressor into four main types.

Accordingly, the processor may model the AC of the air compressor using a Gaussian mixture model (GMM) using four Gaussian distributions, as expressed in Equation 10 below.

$${P}_{GMM} ( {x}_{AC , t} ) = {\sum }_{k = 1}^{4} {P}_{k} ( {x}_{AC , t} ) = {\sum }_{k = 1}^{4} {π}_{k} 𝒩 ( {x}_{AC , t} ; {μ}_{k} , {σ}_{k} ) \qquad < Equation 10 >$$

Here, x_{AC,t} may be an AC value, and the difference in feature values between the BOV and the IGV may be defined as x_{BOV,t}−x_{IGV,t}. In this case, the mean (μₖ) and standard deviation (σₖ), which are parameters of each Gaussian distribution included in the GMM, may be optimized using an expectation-maximization (EM) algorithm based on an actual operational dataset.

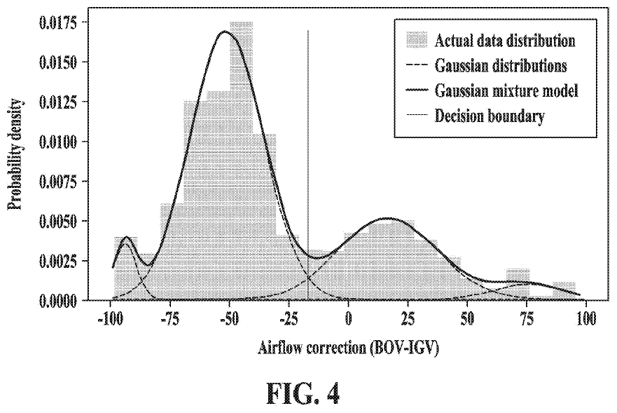

For example, FIG. 4 is a diagram illustrating a probability density distribution of AC data to which a GMM is applied. The magnitude of an AC value is likely to be greater when an operating point of an air compressor is near a surge line or choke line compared to when the operating point of the air compressor is in a stable operating zone. Therefore, as shown in FIG. 4, operating points near the surge line or choke line may appear as extreme values in a Gaussian distribution. In contrast, two Gaussian distributions with means positioned in the middle may represent operating points in the stable operating zone.

The processor may utilize this GMM to determine whether air leakage occurs in the air compressor, as expressed in Equation 11 below.

$${y}_{t} = \{ \begin{matrix}1 & if {\sum }_{k = 1}^{2} {P}_{k} ( {x}_{AC , t} ) < {\sum }_{k = 3}^{4} {P}_{k} ( {x}_{AC , t} ) \\ 0 & otherwise\end{matrix} . \qquad < Equation 11 >$$

That is, the processor may determine that air leakage occurs in the air compressor when an AC value belongs to upper two Gaussian distributions indicating an abnormal operating state and may determine that the air compressor is in a normal state when the AC value belongs to lower two Gaussian distributions indicating a normal operating state.

Additionally, the processor may determine whether air leakage occurs in the air compressor by setting a decision boundary x_{AC,t}. In this case, the decision boundary x*_{AC,t} may be found using various algorithms that satisfy

$${\sum }_{k = 1}^{2} {P}_{k} ( {x}_{AC , t}^{*} ) = {\sum }_{k = 3}^{4} {P}_{k} ( {x}_{AC , t}^{*} ) ,$$

and the processor may use this decision boundary to label data that is not included in the GMM.

The components described in the embodiments may be implemented by hardware components including, for example, at least one DSP, a processor, a controller, an application-specific integrated circuit (ASIC), a programmable logic element, such as a field programmable gate array (FPGA), other electronic devices, or combinations thereof. At least some of the functions or the processes described in the embodiments may be implemented by software, and the software may be recorded on a recording medium. The components, the functions, and the processes described in the embodiments may be implemented by a combination of hardware and software.

The embodiments described herein may be implemented using a hardware component, a software component and/or a combination thereof. For example, the device, the method, and the components described in the embodiments may be implemented using a general-purpose or special-purpose computer, such as a processor, a controller and an arithmetic logic unit (ALU), a DSP, a microcomputer, an FPGA, a programmable logic unit (PLU), a microprocessor, or any other devices capable of responding to and executing instructions. A processing device may run an operating system (OS) and a software application that runs on the OS. The processing device may also access, store, manipulate, process, and generate data in response to execution of software. For purpose of simplicity, the description of a processing device is used as singular; however, one skilled in the art will appreciate that a processing device may include a plurality of processing elements and/or a plurality of types of processing elements. For example, the processing device may include a plurality of processors or a single processor and a single controller. In addition, different processing configurations are possible, such as parallel processors.

The software may include a computer program, a piece of code, an instruction, or some combination thereof, to independently or collectively instruct or configure the processing device to operate as desired. Software and/or data may be stored in any type of machine, component, physical or virtual equipment, or computer storage medium or device capable of providing instructions or data to or being interpreted by the processing device. The software may also be distributed over network-coupled computer systems so that the software is stored and executed in a distributed fashion. The software and data may be stored in a non-transitory computer-readable storage medium.

The method according to the embodiments described above may be recorded in non-transitory computer-readable storage media including program instructions to implement various operations of the embodiments described above. The non-transitory computer-readable storage media may also store, alone or in combination with the program instructions, data files, data structures, and the like. The program instructions recorded on the media may be those specially designed and constructed for the purposes of embodiments, or they may be of the kind well-known and available to those having skill in the computer software arts. Examples of non-transitory computer-readable storage media include magnetic media such as hard disks, floppy disks, and magnetic tape; optical media such as compact disc read-only memory (CD-ROM) discs and digital video discs (DVDs); magneto-optical media such as floptical disks; and hardware devices that are specifically configured to store and perform program instructions, such as ROM, random-access memory (RAM), flash memory, and the like. Examples of program instructions include both machine code, such as produced by a compiler, and files containing higher-level code that may be executed by the computer using an interpreter.

The hardware devices described above may be configured to act as one or more software modules in order to perform the operations of the embodiments described above, or vice versa.

As described above, although the embodiments have been described with reference to the limited drawings, one of ordinary skill in the art may apply various technical modifications and variations based thereon. For example, suitable results may be achieved if the described techniques are performed in a different order, and/or if components in a described system, structure, device, or circuit are combined in a different manner, and/or replaced or supplemented by other components or their equivalents.

Therefore, other implementations, other embodiments, and equivalents to the claims are also within the scope of the following claims.

What is claimed is:

1. An electronic device comprising:
at least one processor; and
memory comprising one or more storage media storing instructions,
wherein the instructions, when executed by the at least one processor individually or collectively, cause the electronic device to:
in operating states of an inlet guide vane (IGV) and a bleed off valve (BOV) of an air compressor, receive operational data measured via at least one sensor disposed in the air compressor;
extract feature data by inputting the received operational data to a first neural network and embedding the received operational data in a latent space;
predict an IGV value and a BOV value of the air compressor by inputting the extracted feature data to a second neural network; and
predict an air leakage probability in the air compressor by inputting the predicted IGV value and the predicted BOV value to a third neural network.

2. The electronic device of claim 1, wherein the first neural network comprises a plurality of fully connected layers connected one after another.

3. The electronic device of claim 2, wherein the instructions, when executed by the at least one processor individually or collectively, cause the electronic device to extract the feature data by converting the received operational data into a dimension corresponding to a number of nodes of a last fully connected layer among the plurality of fully connected layers.

4. The electronic device of claim 1, wherein the second neural network comprises a plurality of fully connected layers configured to independently predict the IGV value and the BOV value of the air compressor.

5. The electronic device of claim 1, wherein the instructions, when executed by the at least one processor individually or collectively, cause the electronic device to independently predict the IGV value and the BOV value of the air compressor by inputting the extracted feature data to each of the plurality of fully connected layers.

6. The electronic device of claim 1, wherein the second neural network is a result of training using a first loss function for minimizing a prediction error of the predicted IGV value, a prediction error of the predicted BOV value, and a prediction error of a predicted airflow correction (AC) value between the BOV and the IGV.

7. The electronic device of claim 1, wherein the second neural network is a result of training using a second loss function to which triplet loss is applied for distinguishing, based on the predicted IGV value and the predicted BOV value, between an air leakage state and a normal state.

8. The electronic device of claim 1, wherein the third neural network comprises a softmax layer and a plurality of fully connected layers connected one after another.

9. The electronic device of claim 1, wherein the third neural network is a result of training using a third loss function to which binary cross-entropy loss is applied for minimizing a difference between the predicted air leakage probability and an actual air leakage probability.

10. The electronic device of claim 1, wherein the instructions, when executed by the at least one processor individually or collectively, cause the electronic device to determine that air leakage occurs in the air compressor when the predicted air leakage probability is greater than or equal to a predetermined threshold.

11. The electronic device of claim 1, wherein the instructions, when executed by the at least one processor individually or collectively, cause the electronic device to:
predict an airflow correction (AC) value from the predicted IGV value and the predicted BOV value; and
analyze whether air leakage occurs in the air compressor by applying the predicted AC value to a Gaussian mixture model (GMM).

12. The electronic device of claim 11, wherein the instructions, when executed by the at least one processor individually or collectively, cause the electronic device to determine, using the predicted AC value and a decision boundary set in the GMM comprising a first number of Gaussian distributions representing AC values in a normal state and a second number of Gaussian distributions representing AC values in an air leakage state, whether air leakage occurs in the air compressor.

13. The electronic device of claim 12, wherein the decision boundary set in the GMM is defined as a point at which a sum of probability densities of the first number of Gaussian distributions is equal to a sum of probability densities of the second number of Gaussian distributions.

14. The electronic device of claim 1, wherein the operational data comprises at least one of temperature, humidity, pressure, maximum load, minimum load, and compressed air temperature within the air compressor.

15. A method of operating an electronic device, the method comprising:
in operating states of an inlet guide vane (IGV) and a bleed off valve (BOV) of an air compressor, receiving operational data measured via at least one sensor disposed in the air compressor;
extracting feature data by inputting the received operational data to a first neural network and embedding the received operational data in a latent space;
predicting an IGV value and a BOV value of the air compressor by inputting the extracted feature data to a second neural network; and
predicting an air leakage probability in the air compressor by inputting the predicted IGV value and the predicted BOV value to a third neural network.

16. The method of claim 15, wherein
the first neural network comprises a plurality of fully connected layers connected one after another, and
the extracting of the feature data comprises extracting the feature data by converting the received operational data into a dimension corresponding to a number of nodes of a last fully connected layer among the plurality of fully connected layers.

17. The method of claim 15, wherein
the second neural network comprises a plurality of fully connected layers configured to independently predict the IGV value and the BOV value of the air compressor, and
the predicting of the IGV value and the BOV value of the air compressor comprises independently predicting the IGV value and the BOV value of the air compressor by inputting the extracted feature data to each of the plurality of fully connected layers.

18. The method of claim 15, wherein the second neural network is a result of training using a first loss function for minimizing a prediction error of the predicted IGV value, a prediction error of the predicted BOV value, and a prediction error of a predicted airflow correction (AC) value between the BOV and the IGV and using a second loss function to which triplet loss is applied for distinguishing, based on the predicted IGV value and the predicted BOV value, between an air leakage state and a normal state.

19. The method of claim 15, wherein
the third neural network comprises a softmax layer and a plurality of fully connected layers connected one after another and is a result of training using a third loss function to which binary cross-entropy loss is applied for minimizing a difference between the predicted air leakage probability and an actual air leakage probability, and
the predicting of the air leakage probability in the air compressor comprises determining that air leakage occurs in the air compressor when the predicted air leakage probability is greater than or equal to a predetermined threshold.

20. The method of claim 15, wherein
the predicting of the air leakage probability in the air compressor comprises:
predicting an airflow correction (AC) value from the predicted IGV value and the predicted BOV value; and
analyzing whether air leakage occurs in the air compressor by applying the predicted AC value to a Gaussian mixture model (GMM), and
the analyzing of whether air leakage occurs in the air compressor comprises determining, using the predicted AC value and a decision boundary set in the GMM comprising a first number of Gaussian distributions representing AC values in a normal state and a second number of Gaussian distributions representing AC values in an air leakage state, whether air leakage occurs in the air compressor.
